(19) United States
(12) Patent Application Publication
(10) Pub. No.: US 2021/0200955 A1
(43) Pub. Date: Jul. 1, 2021

(54) SENTIMENT ANALYSIS FOR FRAUD DETECTION

(71) Applicant: PayPal, Inc., San Jose, CA (US)

(72) Inventors: Liron Ben Kimon, Tel Aviv (IL); Adi Watzman, Tel Aviv (IL); Bradley Wardman, Scottsdale, AZ (US); Yotam Perkal, Tel Aviv (IL)

(21) Appl. No.: 16/732,209

(22) Filed: Dec. 31, 2019

(51) Int. Cl. G06F 40/30; G06F 40/216; G06F 17/16; G06Q 20/40; G06N 3/04; G06F 21/55

(52) U.S. Cl. CPC G06F 40/30; G06F 40/216; G06F 17/16; G06F 21/554; G06N 3/0472; G06N 3/0445; G06Q 20/4016

(57) ABSTRACT

Methods and systems for creating and analyzing encoded vector information from user activities relative to one or more services and/or devices are described. Sentiment analysis using natural language processing can be performed on user activity and a determination can be made as to whether the sentiment of a user account has fraudulent or benign sentiment. Should a fraudulent account sentiment be determined, mitigation measures may be taken including flagging and restricting a user account.

### TECHNICAL FIELD

The subject technology generally relates to natural language processing and more particularly, relates to using sentiment analysis to detect fraud.

### BACKGROUND

Malicious users are a big problem for web services. Fraudsters are constantly finding new ways to circumvent risk mitigations causing loss for a variety of service providers and customers. Fraud techniques are constantly changing and evolving, and new fraud trends keep emerging. Businesses are constantly trying to detect and remove malicious users from stealing money and information including user data.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 is a block diagram of an example computing system for creating and analyzing of vector representations of user activity information.

FIG. 2 is a block diagram of an example computer system suitable for implementing one or more devices of the computing system in FIG. 1.

FIG. 3 is a flow diagram illustrating an example process for creating and analyzing of vector representations of user activity information.

FIG. 4 illustrates an example of components of the system for creating and analyzing of vector representations of user activity information.

### DETAILED DESCRIPTION

Malicious users are constantly finding new ways to circumvent fraud detection mechanisms. Since fraud techniques are constantly changing and evolving and new fraud trends keep emerging, new models for detection are needed to improve current techniques. The disclosed approaches invoke new technical methods for identifying fraudulent accounts by relying on the fact that account actions are ordered sequences of events. Embodiments of the present disclosure model each account action as a word, each series of actions (or a session) as a sentence, and each account as a document and utilize sentiment analysis, a natural language processing (NLP) approach that can be performed on bodies of text, to determine a fraudulent sentiment of the account. Instead of classifying text (e.g., a tweet, blog post, review) as having a positive/negative sentiment, the disclosed techniques classify the account as having a fraudulent/benign sentiment. Thus, a series of actions on a web-based platform (or other system) may be categorized and analyzed using NLP to uncover tendencies that may indicate a higher (or lower) risk from certain types of user accounts that have performed those actions. Note that “fraudulent sentiment” in various embodiments may indicate a propensity of an account to engage in various prohibited transactions (e.g. the sentiment may in some instances cover actions that are not necessarily “fraud” per se).

A vocabulary may be constructed of all possible account actions encoded as input vectors (e.g., one-hot encoded). Then, an auto-encoder or a word2vec algorithm may be used to reduce the dimensionality and create an embedding in which similar actions are mapped close to each other in the new (vector) space. Then a neural network (e.g., a recurrent neural network (RNN)/long short-term memory (LSTM)) may be used in order to perform sentiment analysis and determine the fraudulent sentiment of accounts. Once the model is trained on existing data, the model may be able to predict the fraudulent sentiment of any new or existing account given an input sequence of account actions. In response to the determination that an account has a fraudulent sentiment, actions may be taken to confirm the determination, take corrective action, mitigate the risk, and/or restrict a malicious user.

Word2vec is a group of related models that are used to produce word embeddings. The models may be shallow, two-layer neural networks that are commonly used to reconstruct linguistic contexts of words of a given language in a compact form. Word2vec takes as its input a large corpus of text and produces a vector space, often of several hundred dimensions (e.g., 300 dimensions to represent the English vocabulary). Each unique word in the corpus is assigned a corresponding vector in the space. Word vectors are positioned in the vector space such that words that share common contexts in the corpus are located in close proximity to one another in the space. Other embedding and training algorithms such as FastText may be used similarly like word2vec as understood by one of ordinary skill.

NLP techniques like word2vec may be adapted in a unique and unusual manner by training the model on a corpus of user actions when using a service/application/web site, rather than training the model on words and natural language. More specifically, each user action may be represented in a similar manner to which words are typically represented, and the vectors would represent browsing behavior (or other actions taken relative to an application and/or computer system such as a web server) as opposed to written strings of text. The corpus thus will consist of all the actions a user takes, including delays in taking actions, according to various embodiments. These actions may be recorded relative to sessions engaged in by a user. A session may be defined as all the actions taken by a user between the times when the user connects to the service/application/web site, until the user exits the service/application/web site. (In some embodiments, one session may be modeled as a “sentence” for NLP analysis purposes.) By representing the actions of users in this manner, certain metrics and analyses may then be generated based on detected patterns in order to detect fraudulent actions or series of actions of users.

In some embodiments, sentence and/or paragraph vectors may be calculated in addition to word vectors. Thus, a vector can be calculated for a user session or an entire user account history.

Sentiment analysis includes a set of techniques used to detect favorable and unfavorable opinions in a text. It is used, for example, by businesses to monitor reputation online and to automatically determine whether a review is a positive, negative, or neutral one.

Malicious or fraudulent user actions may include account take overs, linking an account with a stolen or fraudulent bank/credit card account, unauthorized account access, unauthorized accessing of another user's account/information, and actions to make a service more difficult for other users to access (e.g. denial of service).

For example, a malicious user or ring of malicious users may use similar techniques to commit fraudulent account actions. They may set up a synthetic user account to use a stolen bank account. In another example, a user may sign up for an account with no browser history or cache, with an email address that has no other account associations, a phone number that is a voice over internet protocol (VoIP), or an address that is not on any map or is the address of a building that maybe a suspicious type for account creation, such as a hospital. In each of these examples, a single user action may not itself indicate fraud. However, there may be certain behaviors that may build a story of fraud that may be detected using the disclosed techniques. Each of the actions of the user may be benign in isolation, but indicate fraud when combined in a particular order. For example, some malicious users will learn a set of steps to perform to commit some fraudulent activity, perhaps because this is the set of steps they were taught or the pattern their group uses. The malicious user may then perform the same set of actions for each time they commit fraud. While the individual actions may be benign, once identified as a fraudulent pathway, this combination of actions may be determined to be fraudulent. More specifically, users may also engage in transaction types and amounts that are indicative of patterns used in fraud, but these patterns may be subtle and difficult or impossible to detect using human analysis or other types of computerized analysis (even including other machine learning/artificial intelligence techniques).

This specification includes references to “one embodiment,” “some embodiments,” or “an embodiment.” The appearances of these phrases do not necessarily refer to the same embodiment. Particular features, structures, or characteristics may be combined in any suitable manner consistent with this disclosure.

“First,” “Second,” etc. as used herein, are used as labels for nouns that they precede, and do not necessarily imply any type of ordering (e.g., spatial, temporal, logical, cardinal, etc.). Furthermore, various components may be described or claimed as “configured to” perform a task or tasks. In such contexts, “configured to” is used to connote structure by indicating that the components include structure (e.g., stored logic) that performs the task or tasks during operation. As such, the component can be said to be configured to perform the task even when the component is not currently operational (e.g., is not on). Reciting that a component is “configured to” perform one or more tasks is expressly intended not to invoke 35 U.S.C. § 112(f) for that component.

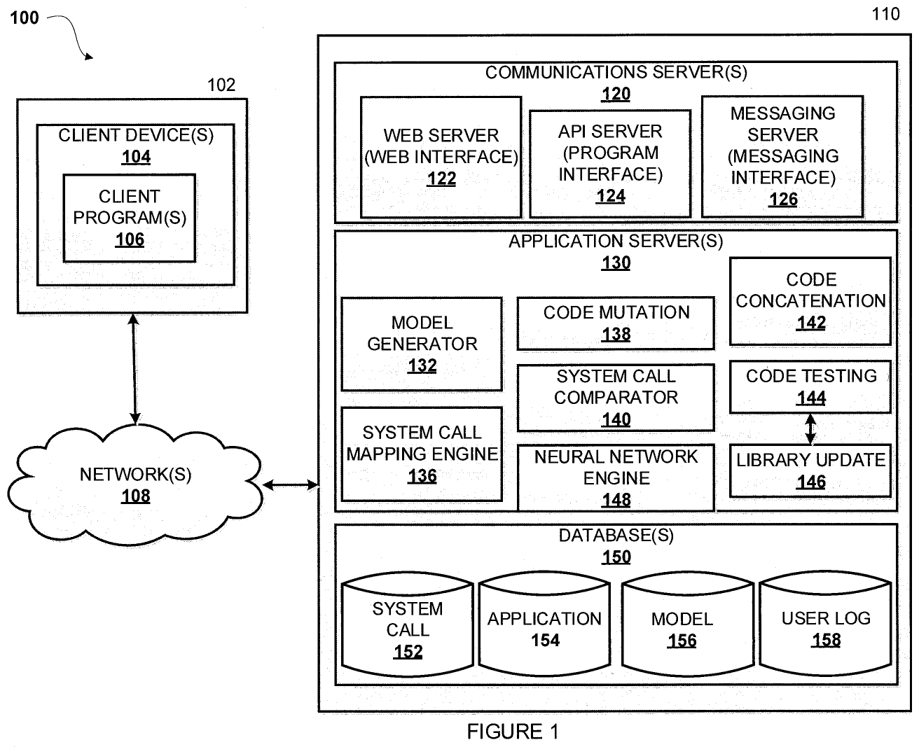

FIG. 1 illustrates an example embodiment of a computing system 100 adapted for implementing one or more embodiments disclosed herein to perform sentiment analysis on user actions to detect fraud. As shown, a computing system 100 may comprise or implement a plurality of servers, devices, and/or software components that operate to perform various methodologies in accordance with the described embodiments. Example servers, devices, and/or software components may include, for example, stand-alone and enterprise-class servers running an operating system (OS) such as a MICROSOFT® OS, a UNIX® OS, a LINUX® OS, or other suitable OS. It may be appreciated that the servers illustrated in FIG. 1 may be deployed in other ways and that the operations performed and/or the services provided by such servers may be combined, distributed, and/or separated for a given implementation and may be performed by a greater number or fewer number of servers. One or more servers may be operated and/or maintained by the same or different entities.

Computing system 100 may include, among various devices, servers, databases and other elements, one or more clients 102 comprising or employing one or more client devices 104, such as a laptop, a mobile computing device, a tablet, a personal computer, a wearable device, and/or any other computing device having computing and/or communications capabilities in accordance with the described embodiments. Client devices 104 may include a cellular telephone, smart phone, electronic wearable device (e.g., smart watch, virtual reality headset), or other similar mobile devices that a user may carry on or about his or her person and access readily.

Client devices 104 generally may provide one or more client programs 106, such as system programs and application programs to perform various computing and/or communications operations. Example system programs may include, without limitation, an operating system (e.g., MICROSOFT® OS, UNIX® OS, LINUX® OS, Symbian OS™, iOS, Android, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Example application programs may include, without limitation, a payment system application, a web browser application, messaging application, contacts application, calendar application, electronic document application, database application, media application (e.g., music, video, television), location-based services (LBS) application (e.g., GPS, mapping, directions, positioning systems, geolocation, point-of-interest, locator) that may utilize hardware components such as an antenna, and so forth. One or more of client programs 106 may display various graphical user interfaces (GUIs) to present information to and/or receive information from one or more users of client devices 104. In some embodiments, client programs 106 may include one or more applications configured to conduct some or all the functionalities and/or processes discussed herein.

As shown, client devices 104 may be communicatively coupled via one or more networks 108 to a network-based system 110. Network-based system 110 may be structured, arranged, and/or configured to allow client 102 to establish one or more communications sessions between network-based system 110 and various client devices 104 and/or client programs 106. Accordingly, a communications session between client devices 104 and network-based system 110 may involve the unidirectional and/or bidirectional exchange of information and may occur over one or more types of networks 108 depending on the mode of communication. While the embodiment of FIG. 1 illustrates a computing system 100 deployed in a client-server operating environment, it is to be understood that other suitable operating environments and/or architectures may be used in accordance with the described embodiments.

Data communications between client devices 104 and the network-based system 110 may be sent and received over one or more networks 108 such as the Internet, a WAN, a WWAN, a WLAN, a mobile telephone network, a landline telephone network, personal area network, as well as other suitable networks. For example, client devices 104 may communicate with network-based system 110 over the Internet or other suitable WAN by sending and or receiving information via interaction with a website, an application, e-mail, IM session, and/or video messaging session. Any of a wide variety of suitable communication types between client devices 104 and system 110 may take place, as will be readily appreciated. In particular, wireless communications of any suitable form (e.g., Bluetooth, near-field communication, etc.) may take place between client device 104 and system 110, such as that which often occurs in the case of mobile phones or other personal and/or mobile devices.

Network-based system 110 may comprise one or more communications servers 120 to provide suitable interfaces that enable communication using various modes of communication and/or via one or more networks 108. Communications servers 120 may include a web server 122, an application programming interface (API) server 124, and/or a messaging server 126 to provide interfaces to one or more application servers 130. Application servers 130 of network-based system 110 may be structured, arranged, and/or configured to provide various online services to client devices that communicate with network-based system 110. In various embodiments, client devices 104 may communicate with application servers 130 of network-based system 110 via one or more of a web interface provided by web server 122, a programmatic interface provided by API server 124, and/or a messaging interface provided by messaging server 126. It may be appreciated that web server 122, API server 124, and messaging server 126 may be structured, arranged, and/or configured to communicate with various types of client devices 104, and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, mobile applications, and so forth. API server 124 may be arranged to communicate with various client programs 106 comprising an implementation of API for network-based system 110, such as a Simple Object Access Protocol (SOAP) or Representational State Transfer (REST) API. Messaging server 126 may be arranged to communicate with various messaging clients and/or applications such as e-mail, IM, SMS, MMS, telephone, VoIP, video messaging, IRC, and so forth, and messaging server 126 may provide a messaging interface to enable access by client 102 to the various services and functions provided by application servers 130.

Application servers 130 of network-based system 110 may be servers that provide various services to client devices, such as tools for authenticating users and associated libraries. Application servers 130 may include multiple servers and/or components. For example, application servers 130 may include a model generator 132, system call mapping engine 136, code mutation engine 138, system call comparison engine 140, code concatenation engine 142, testing engine 144, library update engine 146, and/or neural network engine 148. These servers and/or components, which may be in addition to other servers, may be structured and arranged to identify fraudulent users/user accounts

Application servers 130, in turn, may be coupled to and capable of accessing one or more databases 150 including system call database 152, application database 154, model database 156, and activity log database 158 which may also include logs of user actions on a network-accessible software service. These user logs may include user device information, access method, and service used. Databases 150 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments.

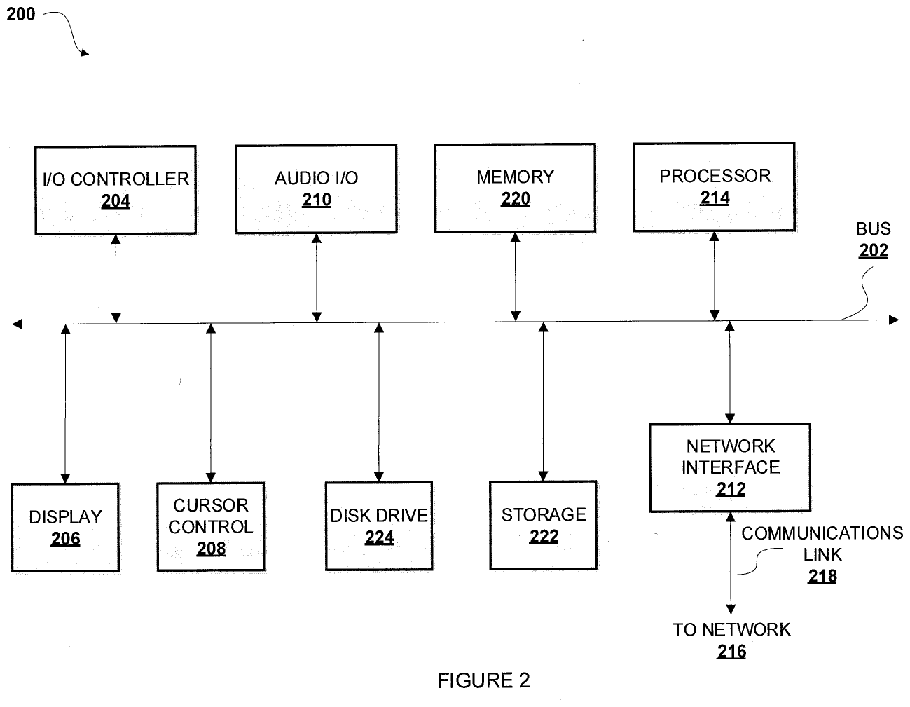

FIG. 2 illustrates an example computer system 200 in block diagram format suitable for implementing on one or more components of the computing system in FIG. 1. In various implementations, a device that includes computer system 200 may comprise a personal computing device (e.g., a smart or mobile phone, a computing tablet, a personal computer, laptop, wearable device, PDA, etc.) that is capable of communicating with a network. A service provider and/or a content provider may utilize a network computing device (e.g., a network server) capable of communicating with the network. It should be appreciated that each of the devices utilized by users, service providers, and content providers may be implemented as computer system 200 in a manner as follows. Additionally, as more and more devices become communication capable, such as smart devices using wireless communication to report, track, message, relay information and so forth, these devices may be part of computer system 200.

Computer system 200 may include a bus 202 or other communication mechanisms for communicating information data, signals, and information between various components of computer system 200. Components include an input/output (I/O) controller 204 that processes a user action, such as selecting keys from a keypad/keyboard, selecting one or more buttons, links, actuatable elements, etc., and sends a corresponding signal to bus 202. I/O controller 204 may also include an output component, such as a display 206 and a cursor control 208 (such as a keyboard, keypad, mouse, touchscreen, etc.). In some examples, I/O controller 204 may include an image sensor for capturing images and/or video, such as a complementary metal-oxide semiconductor (CMOS) image sensor, and/or the like. An audio I/O component 210 may also be included to allow a user to use voice for inputting information by converting audio signals. Audio I/O component 210 may allow the user to hear audio.

A transceiver or network interface 212 transmits and receives signals between computer system 200 and other devices, such as another user device, a merchant server, an email server, application service provider, web server, a payment provider server, server clusters, and/or other servers via a network. In various embodiments, such as for many cellular telephone and other mobile device embodiments, this transmission may be wireless, although other transmission mediums and methods may also be suitable. A processor 214, which may be a micro-controller, digital signal processor (DSP), or other processing component, processes these various signals, such as for display on computer system 200 or transmission to other devices over a network 216 via a communication link 218. Again, communication link 218 may be a wireless communication in some embodiments. Processor 214 may also control transmission of information, such as cookies, IP addresses, images, and/or the like to other devices.

Components of computer system 200 also include a system memory 220 (e.g., RAM), a static storage component 222 (e.g., ROM), and/or a disk drive 224. Computer system 200 performs specific operations by processor 214 and other components by executing one or more sequences of instructions contained in system memory 220. Logic may be encoded in a computer-readable medium, which may refer to any medium that participates in providing instructions to processor 214 for execution. Such a medium may take many forms, including but not limited to, non-volatile media, volatile media, and/or transmission media. In various implementations, non-volatile media includes optical or magnetic disks, volatile media includes dynamic memory such as system memory 220, and transmission media includes coaxial cables, copper wire, and fiber optics, including wires that comprise bus 202. In one embodiment, the logic is encoded in a non-transitory machine-readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein may be embodied in one or more computer readable media or be in communication with one or more processors to execute or process the techniques and algorithms described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer-readable media. It is also contemplated that software identified herein may be implemented using one or more computers and/or computer systems, networked and/or otherwise. Such software may be stored and/or used at one or more locations along or throughout the system, at client 102, network-based system 110, or both. Where applicable, the ordering of various steps described herein may be changed, combined into composite steps, and/or separated into sub-steps to provide features described herein.

The foregoing networks, systems, devices, and numerous variations thereof may be used to implement one or more services, such as the services discussed above and, in more detail, below.

Machine learning algorithms typically require the data used to be represented numerically. Databases or user usage logs contain a listing of user actions. Specifically, when browsing sessions of users are broken down to the event-level—e.g., all the different webpages that the user visits and how the webpage was accessed (e.g., device type, which entry point, such as a geographic entry point, was used to access the page), clicks that are made, including registration, login, payment account details, bank transfer, etc.—the data ends up being massive and thus very highly-dimensional. The hundreds of thousands of different events and webpages associated with modern services could potentially result in as many dimensions. Thus, an algorithm that attempts to leverage the usage history can produce an accurate and compact representation of the data. Applying the word2vec algorithm, which is commonly used for natural language processing (NLP), to a user's usage history with a service, a system can provide a manner in which the actions of the user may be efficiently organized in a compact representation, and subsequently leveraged to produce useful predictions and reports.

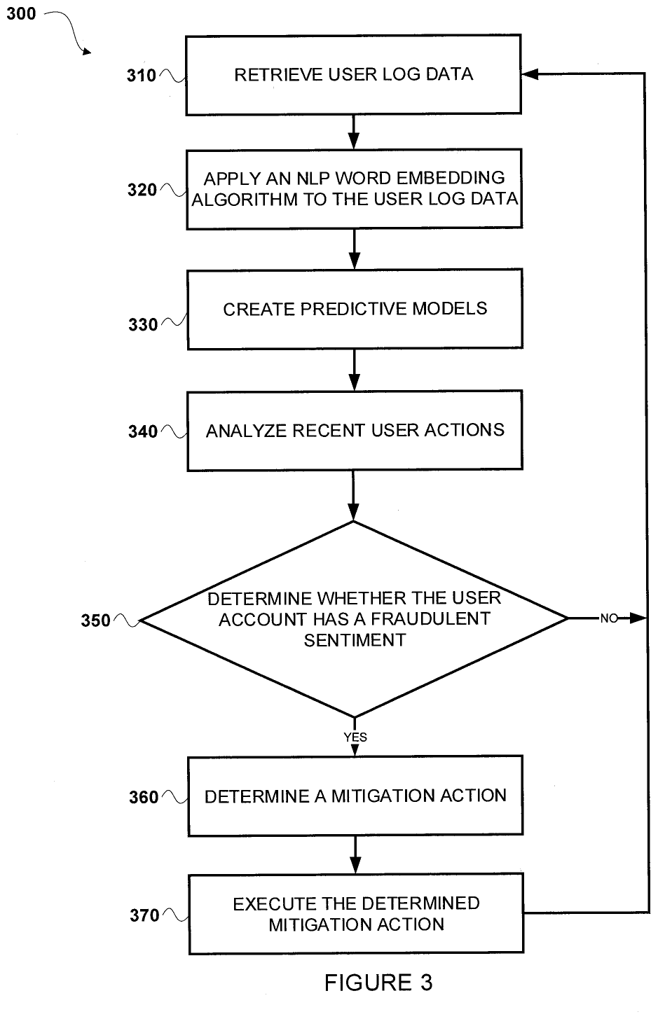

FIG. 3 is a flow diagram illustrating an example process for creating and analyzing user actions using natural language processing and sentiment analysis, according to some embodiments. One or more aspects of process 300 may be performed by system 110, system 200, or any other suitable computer system, in various embodiments. For ease of explanation, however, various operations below will be discussed relative to particular systems (e.g. system 110).

In step 310, user log data for a particular network-accessible software service is retrieved by the system 110. This log data may include data representing all the network traffic for each individual user on a particular website/software application may be obtained. The network-accessible software service may include one or more of one or more websites or one or more applications. The historical data may include any combination of information regarding a user's use and access of a network-accessible software service including metadata about the context of the user's use of the service. For example, historical data may include data about the page/screen accessed (e.g., an address and/or title), page generation statistics (e.g., page generation time and page loading time) information about the device accessing the software service (e.g. device type, operating system and version, browser and version, software version, screen resolution, session identifier, network identifier), the time of the access request, user clicks and cursor movement on the interface of the page or graphical user interface (GUI) and interface elements interacted with (e.g., buttons clicked, menus accessed), what entry point or uniform resource locator (URL) was used to access the current page, a waiting period of time between performing account actions, IP address of the user device, a user identifier, user device location (country or city of access), the data and time of the user request, the HTTP request made to server 110, the status code returned, and the size of the object (image, video, HTML page, document) returned, and/or what a user accessed prior to the current page/screen. Transaction information may also be included in the historical data, e.g., registering/opening an account, logging into an account, changing a setting associated with the account, purchases or sales, item or service bought or sold. Additional transaction feature data that may be logged and that may be used as part of the vocabulary for NLP may include price of an item or items purchased or location of a merchant from which an item was bought.

For example, a first user may access the network-accessible software service from a browser on their computer, register an account, log in to the service, makes a transaction, and logs out. The first user may access the network-accessible software service a second time from their phone, log in to the service and update personal settings associated with their account, security settings, and their session times out from inactivity. Each of the foregoing actions of the first user may be logged by the network-accessible software service along with metadata.

In this example, a second user may access the network-accessible software service from their user device using a browser on their computer and then logs out. A few days later the second user may log into the account and change user information such as the phone number associated with the account and make a small donation. A few days later the second user may make a large purchase. Each of the foregoing actions of the second user may be logged by the network-accessible software service along with additional metadata (as described above).

In this example, the usage of both the first user and the second user may be co-mingled in the same usage logs. In this case, system 110 may filter the logs by user prior to parsing them to perform NLP. In another example, each user will have their own segregated logging.

System 110 may parse these user logs of the network-accessible software service. In some embodiments, the user logs will be in a standard format. System 110 may filter the logs by a username, IP address, or other identifying characteristic of a user. The filtered logs may then be parsed for relevant user actions and the actions extracted. In embodiments where the usage logs are stored in a database, data of a particular user can be filtered and desired data extracted. In a flat file storage, logs can be parsed and then the data filtered or sorted to get the desired data for a particular user.

In step 320, the system 110 applies a Natural Language Processing (NLP) word embedding algorithm, such as autoencoder or word2vec, to the retrieved user log data to generate a low-dimensional embedding. The user log data may be found in usage logs in flat files, in database entries, or in any other data format in various embodiments. The system 110 may convert the log data into data that is more easily usable for processing using autoencoder/word2vec. For example, a data structure (set of arrays, a document, etc.) may be used as input for vectorization. Log data may be mined and converted to words or symbols. For example, each user action may correspond to a word, a session to a sentence, and a user account's action history to a document for use in a word2vec application. This may include encoding strings with representations for different account actions. The strings may represent word2vec sentences and user sessions. The set of arrays or lists include an array of strings to represent the full account history of a user. Pre-processing of the user log data may also include tokenization of user actions.

In some embodiments, system 110 may parse the listing of all different actions in the usage logs and determine the frequency of each action. The system may assign a symbol to each action. In some examples, the symbols assigned are preassigned. In other examples, the symbols are assigned in order of use (e.g., the first action encountered is assigned 0, then 1, etc.) In one example, each action is assigned a binary value with the most frequent actions assigned the shortest binary values using an algorithm such as entropy encoding or Huffman coding. For example, if logging in is the most common action type, it may be assigned the symbol 000 and logging out, if it is the second most common action type, the symbol 111, and infrequently used actions may be assigned comparatively large binary values. In further examples, English words are assigned to actions (e.g., based on the type of action occurring for ease of human parsing) or in any other combination of characters or symbols in various embodiments.

In some examples, multiple types or ranges of actions are combined into the same symbol. This may be useful when there is less data about different subcategories of actions and so the data can be treated as one larger group for analysis. For example, separate symbols may be assigned for logging in or logging in from the North America, logging in from the United States, and logging in from California. Or where the user is in a particular location when performing a transaction or where the recipient is in a particular location. In other examples, all of these different actions may be combined. Similarly, transactions for different dollar amounts may be combined into a single symbol or separated out in various combinations (e.g., transactions under $1, under $10, under between $10 and $100, under between $100 and $1000, between $1000 and $25,000 and above $25,000). Different device types performing the actions may be assigned different symbols or may be combined based on operating system or may be not used as an action differentiator. Delays between actions may be calculated using usage logs and assigned a symbol or multiple symbols (based on the length of the delay).

After actions are assigned symbols, system 110 may generate data structures for each user based on converting the data in the usage logs to symbols, in various embodiments. For example, system 110 may generate a string (or list) of symbols for each user corresponding to the symbols that describe actions taken each session, and an array that correspond to all (or a subset) of the user actions with the network-accessible software service. This data structure may be generated for each user account (or a subset of user accounts).

As discussed above, word2vec is a shallow word embedding model that, in this instance, learns to map discrete user actions into a low-dimensional continuous vector-space based on distributional properties observed from the corpus (e.g., historical data of network traffic). A shallow word embedding model, in contrast to a deep learning model, refers to a machine learning algorithm without multiple middle/hidden-layers. The low-dimensional continuous vector-space refers to an encoding with one or more orders of magnitude less than a dimensional space of source materials. For example, English has hundreds of thousands of words but a vector space representing the language may be 300 or fewer dimensions. When applied to a language, word2vec produces low-dimensional representations that capture relationships between words of a corpus to highlight linguistic regularities. That is, the statistics of how often some word co-occurs with neighboring words in a large text corpus are computed and then mapped to a vector for each word. Once a low-dimensional embedding has been produced, predictive models can then be formulated based on the embedding. The predictive models may, for example, predict a word from its neighbors. Word2vec typically utilizes two model architectures—the continuous bag of words (CBOW) and the skip-gram models. While the two models are algorithmically similar, CBOW is used to predict target words from source context words while the skip-gram does the inverse and predicts source context-words from the target words.

Applying word2vec to user actions using a network-accessible software service produces the unique low-dimensional representations that capture user action regularities. User action vectors are positioned in the vector space in a manner such that actions or sets of actions sharing common contexts in the corpus are located in close proximity to one another in the space. In some examples, user actions are one-hot encoded, where each type of user action is sorted (e.g., based on usage) and then assigned a number.

Once a low-dimensional embedding has been produced, predictive models can then be created in step 330 based on the embedding. Vectors may be inputs to an RNN-based or an LSTM-based model. That is, certain metrics may be determined based on the different clusters of vectors. For example, a group of vectors in the vector space that are known to be associated with fraudulent or malicious activity may be identified. Once identified, the system 110 can determine what types of user actions are likely to produce fraudulent or malicious activity. In other words, the webpage vectors of the low-dimensional embedding may be used to produce a prediction model that anticipates additional actions that the user is likely to take in an active browsing session.

The predictive models may be trained using account actions of known or previously determined fraudulent accounts and/or account actions of known benign user accounts. These accounts may have been determined manually, via other detection techniques to find potentially malicious pathways of actions or individual actions, or prior iterations of the present predictive models. A neural network is trained such that hidden layer weight values are determined based on the input (user action) data. These weight values correspond to “word” vectors that the system 110 tries to learn.

In step 340, following training, the system 110 may analyze recent user actions of an unclassified (or previously classified) user. This user classification may indicate that a transaction account of a user is known to have engaged in account fraud or otherwise performed a transaction that is prohibited by a service provider, or, the classification may indicate the account is a “good” account that is not known to have engaged in any such activity. For example, the system 110 periodically or continuously monitors activity of users using the network-accessible software service. As indicated above, user actions over a particular period are input into the trained system 110. In monitoring the user actions, a sentiment determination is made as to whether the user has: (1) a propensity to perform one or more types of prohibited transactions using the network-accessible software service, (2) a fraudulent account sentiment, and/or (3) a likelihood prohibited user activity was performed on or with the account. A prohibited transaction may include, without limitation, a transaction that is against a service provider's terms of service, or is against the laws or regulations of one or more jurisdictions and/or regulating entities. A sentiment score for a user account is determined for each user account based on a similarity to the trained user actions. In one example embodiment, the sentiment score may be determined based on an average of the vectors of the user actions analyzed (e.g., the entire account or for a particular time period). In another example embodiment, the sentiment score may be determined based on a distance comparison between a vector representing user account actions and one or more vectors representing known fraudulent accounts.

The system 110 may make a determination of whether the user account has a fraudulent account sentiment in step 350. This determination is made based on applying the prediction model to the user activity. Since the prediction model is founded on historical user activity, any current user activity that appears to have a similar pattern as a previously analyzed session of interest (according to the prediction model) may be flagged for review or otherwise recorded in association with a user account that engaged in the activity. Once flagged for review, the system 110 may limit actions the account may take and/or may alert an administrator to review the flagged account. In one embodiment, the sentiment score for the user account may be compared to a threshold value to record the account as having a fraudulent account sentiment. In another embodiment, the sentiment score is compared with multiple threshold values, to determine a mitigation action. In another embodiment, sentiment scores are either 0 (for benign sentiment) and 1 (for fraudulent sentiment) and fraudulent determination indicates a mitigation action may be taken. A range of sentiment scores may be assigned to an account based on classification by the trained model, where a score of 0.00 indicates a strong benign (legitimate) account sentiment, and a score of 1.00 indicates a strong fraudulent sentiment. Scores in between may indicate some propensity toward legitimate usage or potentially fraudulent usage.

If the system 110 determines the user account does not have a fraudulent account sentiment, the process repeats either after a certain time interval (e.g., a few hours, one day, one week, bi-weekly, monthly, semi-annually, annually, or some other time period) or immediately, according to various embodiments. If the system 110 determines the user account has a fraudulent account sentiment, the system 110 may determine a mitigation action in step 360. Mitigation may include measures such as flagging an account for further review. Such review may be manual review or further automated review procedures. Mitigation may also include restricting an account associated with the user, monitoring the account associated with the user, alerting an administrator about the account associated with the user, requiring an identity verification of the user, stopping pending transactions of the user, raising a risk score of the account associated with the user to perform subsequent actions, freezing the account, and/or not allowing the user to change account information, conduct any transactions, and/or halt transactions currently in progress. The risk score may be used to determine a user's overall risk, a monetary limit for transactions, limits to account changes, or require further identification verification from the user including email verification, mobile phone verification, and driver's license/passport revivification.

Thus, as one example, a user account flagged as having fraudulent account sentiment (e.g. over a threshold), may be treated differently by a transaction processing system 110 than an account whose fraudulent sentiment, as determined by the NLP trained model, does not reach that threshold. For example, the system 110 may not allow a user to change an account setting (user's name or address, email address, or phone number; account alerts such as spending limits, or account alteration messages) or add a funding instrument (e.g., a bank account or credit card account), or complete a transaction when the account is determined to have a fraudulent sentiment. Additionally, the account may be deleted or banned from accessing the network-accessible software service. For example, if a user's account is determined to have a fraudulent sentiment, an email or popup notification alerting the user that their account access has been limited may be sent. If a user attempts to change an account setting or add a funding instrument or complete a transaction the action may be disallowed and/or an error can be presented. In another example, the user may be unable to login to the account as the account was banned or disabled.

In step 370, the system 110 may execute the determined mitigating action. Execution of the mitigating action may include changing user settings limiting the user account when the user attempts to perform some activity or transaction. Execution of the mitigation action may include reverting back an action taken by the user account. Additionally, executing the mitigating action may also include sending a message or alert (via, e.g., email, SMS, internal messaging tool, phone or website notification) to an administrator or to the user of the user account.

In some embodiments, a feedback loop may be utilized by the system 110, particularly when newly identified user actions are introduced or a period of time has elapsed. For example, new user actions may include additional information that becomes part of the corpus on which the prediction model is built via word2vec. As such, as new user actions, the corpus grows and the prediction model, with increased training data set, becomes more accurate. For example, new user actions that were not previously available may include previously untaken actions such as entry into the website via an unused or unknown entry point may not have entered the corpus of user actions as there was no or limited context to create a meaningful vector in word2vec for user prediction. Additionally, newly added features by the network-accessible software service may include new user actions not previously available and not part of the corpus.

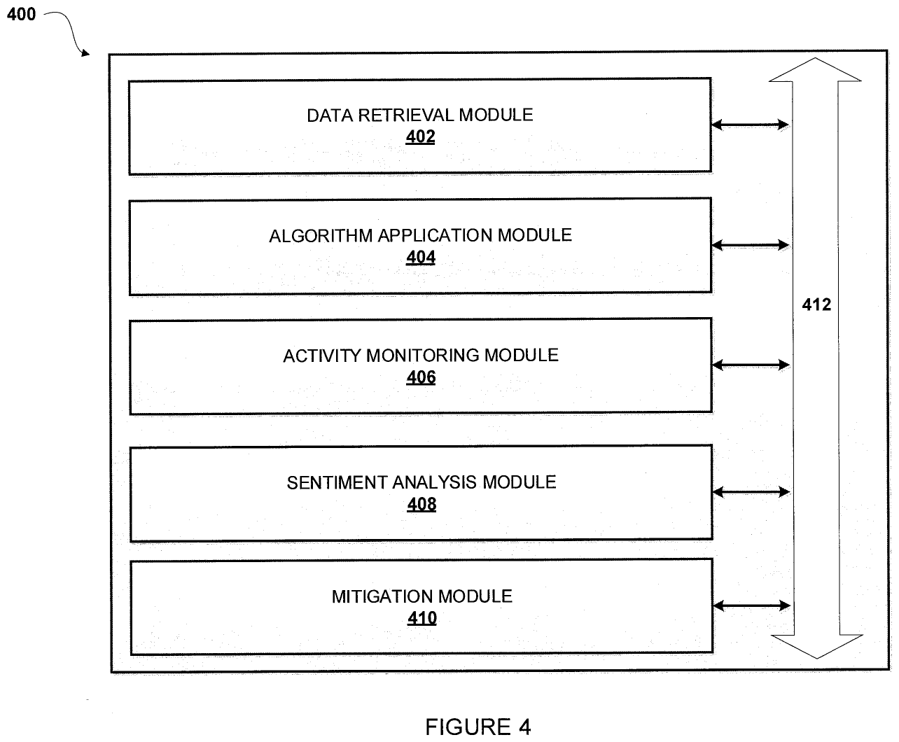

FIG. 4 provides an illustration of components of a system 400 for creating and analyzing of a vectorized sequence of user actions, in accordance with various aspects of the subject technology. System 400 comprises a data retrieval module 402, an algorithm application module 404, an activity monitoring module 406, a sentiment analysis module 408, and a mitigation module 410. These modules may be in communication with one another via a bus 412. In some aspects, the modules may be implemented in software (e.g., subroutines and code). The software implementation of the modules may operate on a client device 104 application that is running a specific language compatible to the modules. In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

Data retrieval module 402 is used to retrieve historical usage data for a network-accessible software service. As discussed above, data representing all network traffic on a particular merchant website may be obtained. This data includes information such as browsing history and interactions performed for each of the many users that have browsed the merchant website, application, or service. Included in this retrieved data is all the webpages visited by each user, and the sequence/order in which the webpages are visited by the users. In other words, this historical usage data may comprise one or more data logs as discussed above.

System 400 further comprises algorithm application module 404 configured to apply one or more natural language processing algorithms (e.g. word2vec) to a corpus, which in this case is the retrieved user activity data including network traffic data. By applying word2vec, a prediction model may be generated. The prediction model is then used against a user's activity that is monitored by way of the activity monitoring module 406. Sentiment analysis is performed on the user's activity to determine whether the account has a fraudulent sentiment or benign sentiment by sentiment analysis module 408. Depending on the result of the sentiment analysis, a user account (or set of user accounts) may be flagged by session mitigation module 410. As discussed above, the system will take one or more mitigation efforts if a fraudulent sentiment is determined.

System 400 is particularly useful for analyzing the way users interact with a particular service or website and does so by representing the corpus of different possible user actions in a manner in which analytics and other types of modeling may be performed. Using word2vec, system 400 is able to efficiently process and represent the corpus in a multi-dimensional vector space. The representation, which are presented as vectors, are then used to predict an account sentiment. Such predictions are useful to help service administrators gain additional understanding and control of their client base.

The user device (i.e., the computing device) described above may be one of a variety of devices including but not limited to a smartphone, a tablet, a laptop and a pair of augmented reality spectacles. Each of these devices embodies some processing capabilities and an ability to connect to a network (e.g., the internet, a LAN, a WAN, etc.). Each device also includes a display element for displaying a variety of information. The combination of these features (display element, processing capabilities and connectivity) on the mobile communications enables a user to perform a variety of essential and useful functions.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order and are not meant to be limited to the specific order or hierarchy presented.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “implementation” does not imply that such implementation is essential to the subject technology or that such implementation applies to all configurations of the subject technology. A disclosure relating to an implementation may apply to all implementations, or one or more implementations. An implementation may provide one or more examples of the disclosure. A phrase such an “implementation” may refer to one or more implementations and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

Furthermore, to the extent that the terms “include,” “have,” and “the like” are used in the description or the claims, such terms are intended to be inclusive in a manner similar to the term “comprise” as “comprise” is interpreted when employed as a transitional word in a claim.

The word “example” is used herein to mean “serving as an example, instance, or illustration.” Any implementation described herein as “example” is not necessarily to be construed as preferred or advantageous over other implementations.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A system comprising:
a non-transitory memory storing instructions; and
one or more hardware processors configured to execute the instructions from the non-transitory memory to cause the system to perform operations comprising:
accessing a log of a sequence of actions taken by a user associated with a network-accessible software service;
generating, using a word embedding algorithm on the sequence of actions, a representation of the sequence of actions within a vector space;
performing a sentiment analysis, using a trained prediction model, on the sequence of actions taken by the user;
determining, based on a result of the sentiment analysis, whether the sequence of actions indicates a propensity of the user to perform one or more types of prohibited transactions using the network-accessible software service;
determining a mitigation action based on determining the sequence of actions indicates the propensity of the user to perform one or more types of prohibited transactions using the network-accessible software service; and
executing the mitigation action.

2. The system of claim 1, wherein the word embedding algorithm is a word2vec algorithm.

3. The system of claim 1, wherein performing the sentiment analysis is based on the word embedding algorithm to determine the propensity of the user to perform the one or more types of prohibited transactions.

4. The system of claim 3, wherein the sentiment analysis is performed on the word embedding algorithm into the vector space.

5. The system of claim 3, wherein the trained prediction model is trained using sequences of user actions known to correspond to user accounts that have been classified as being involved with prohibited sequences of one or more transactions performed via the network accessible software service.

6. The system of claim 1, wherein using the trained prediction model uses a long short-term memory recurrent neural network (LSTM RNN).

7. The system of claim 1, wherein the operations further comprise:
converting the log of actions of the user into a data structure, wherein using the word embedding algorithm is performed on the data structure.

8. The system of claim 7, wherein each session of the user on the network-accessible software service is represented as a sentence in the data structure and each action of the log of the sequence of actions is assigned a different word in a vocabulary of words.

9. The system of claim 1, wherein:
the log of actions of the user on the network-accessible software service comprises an ordered set of actions performed through an account associated with the user on the network-accessible software service, and
the ordered set of actions comprises at least one of: opening the account, logging into the account, changing a setting associated with the account, performing a transaction using the account, or waiting a period of time between performing account actions.

10. The system of claim 1, wherein the mitigation action comprises at least one of: restricting an account associated with the user, monitoring the account associated with the user, alerting an administrator about the account associated with the user, requiring an identity verification of the user, stopping pending transactions of the user, or raising a risk score of the account associated with the user to perform subsequent actions.

11. A method comprising:
accessing a log of a sequence of actions taken through a plurality of user accounts associated with a network-accessible software service;
converting the log of the sequence of actions into a plurality of data structures, each of the plurality of data structures associated with a different user account of the plurality of user accounts;
applying a word embedding algorithm to the plurality of data structures to produce a representation of the sequence of actions within a vector space;
performing a sentiment analysis, using a trained prediction model, on the plurality of data structures;
determining, based on a result of the sentiment analysis, whether one or more sequences of actions in the sequence of actions indicate a fraudulent account sentiment;
determining at least one of the plurality of user accounts has the fraudulent account sentiment based on the sentiment analysis; and
taking a mitigation action for each of the at least one of the plurality of user accounts that has the fraudulent account sentiment.

12. The method of claim 11, wherein determining at least one of the plurality of user accounts has the fraudulent account sentiment comprises:
determining a sentiment score for each of the plurality of user accounts using the trained prediction model, and
comparing the sentiment score for each of the plurality of user accounts with a threshold.

13. The method of claim 12, further comprising selecting the mitigation action again based on the sentiment score for each of the at least one of the at least one of the plurality of user accounts that has the fraudulent account sentiment.

14. The method of claim 11, wherein the sentiment analysis is performed using a long short-term memory recurrent neural network (LSTM RNN).

15. The method of claim 11, wherein each session of a user account of the plurality of user accounts is represented as a sentence in a data structure of the plurality of data structures and each action of the sequence of actions is assigned a different word in a vocabulary representing different user actions.

16. The method of claim 11, wherein the fraudulent account sentiment comprises an indication that an account of the plurality of user accounts has performed one or more prohibited transactions associated with the network-accessible software service.

17. A non-transitory machine-readable medium having stored thereon machine-readable instructions executable to cause performance of operations comprising:
accessing a sequence of actions for a plurality of accounts, the plurality of accounts comprising a plurality of known non-fraudulent accounts and a plurality of known fraudulent accounts, the plurality of known non-fraudulent accounts comprising accounts with a first sequence of actions having a categorized benign sentiment and the plurality of known fraudulent accounts comprising accounts having a second sequence of actions with a categorized fraudulent sentiment;
generating, using a word embedding algorithm on the sequence of actions, a representation of the sequence of actions within a vector space;
accessing a prediction model for sentiment analysis;
applying the representation of the sequence of actions within the vector space to the prediction model using a neural network that is configured to receive an input of a sequence of actions of an unclassified user account and an output a likelihood of prohibited user activity of the unclassified user account;
retrieving the sequence of actions of the unclassified user account; and
determining the likelihood of prohibited user activity of the unclassified user account using the prediction model and the sequence of actions of the unclassified user account.

18. The non-transitory machine-readable medium of claim 17, wherein the operations further comprise converting each distinct action type of the sequences of actions for the plurality of accounts into a separate word or a symbol in a vocabulary of words or symbols for use with the word embedding algorithm.

19. The non-transitory machine-readable medium of claim 18, wherein generating the representation of the sequence of actions within a vector space comprises:
encoding each separate word or symbol in the vocabulary of words or symbols into an input vector in the vector space, and
reducing a dimensionality of each separate word or symbol in the vector space using the word embedding algorithm to create an embedding in which similar words or symbols in the vocabulary of words or symbols are mapped closer in the vector space.

20. The non-transitory machine-readable medium of claim 18, wherein the operations further comprise:
periodically retrieving an updated sequence of actions of the unclassified user account; and
determining an updated likelihood of prohibited user activity of the unclassified user account using the prediction model and the updated sequence of actions of the unclassified user account.
